(19) United States
(12) Patent Application Publication
(10) Pub. No.: US 2007/0146291 A1
(43) Pub. Date: Jun. 28, 2007

(54) Active matrix liquid crystal display and driving method

(75) Inventors: Wei Wang, Miao-Li (TW); An Shih, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/642,121

(22) Filed: Dec. 20, 2006

(30) Foreign Application Priority Data
Dec. 22, 2005 (CN) 200510121036.6

(51) Int. Cl. G09G 3/36

(52) U.S. Cl. 345/100

(57) ABSTRACT

An exemplary active matrix liquid crystal display (LCD) (200) includes a plurality of alternate first gate lines (23) and second gate lines (33) that are parallel to each other and that each extend along a first direction, a plurality of alternate first data lines (24) and second data lines (34) that are parallel to each other and that each extend along a second direction orthogonal to the first direction, a plurality of first TFTs (25), a plurality of second TFTs (35), a gate driving circuit (21) for providing a plurality of first scanning signals to the first gate lines and providing a plurality of second scanning signals to the second gate lines, a data driving circuit (22) for providing gradation voltage to the first data lines when the first gate lines are scanned and providing black-inserting voltage to the second data lines when the second gate lines are scanned.

### FIELD OF THE INVENTION

The present invention relates to liquid crystal displays (LCDs), and particular to an active matrix type LCD which is suitable for motion picture display and a driving method thereof.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 3 is an abbreviated diagram including circuitry of a typical active matrix LCD. The active matrix LCD 10 includes a display panel 107, a data driving circuit 12, and a gate driving circuit 11. The display panel 107 includes a first substrate (not shown), a second substrate (not shown) arranged in a position facing the first substrate, and a liquid crystal layer (not shown) sandwiched between the first substrate and the second substrate.

The first substrate includes a number n (where n is a natural number) of gate lines 13 that are parallel to each other and that each extend along a first direction, and a number k (where k is also a natural number) of data lines 14 that are parallel to each other and that each extend along a second direction orthogonal to the first direction. The first substrate also includes a plurality of thin film transistors (TFTs) 15 that function as switching elements. The first substrate further includes a plurality of pixel electrodes 151 formed on a surface thereof facing the second substrate. Each TFT 15 is provided in the vicinity of a respective point of intersection of the gate lines 13 and the data lines 14. The smallest rectangle area made by the gate lines 13 and the data lines 14 defines a pixel unit (not labeled).

Each TFT 15 includes a gate electrode, a source electrode, and a drain electrode. The gate electrode of each TFT 15 is connected to the corresponding gate line 13. The source electrode of each TFT 15 is connected to the corresponding data line 14. The drain electrode of each TFT 15 is connected to the corresponding pixel electrode 151.

The second substrate includes a plurality of common electrodes 152 opposite to the pixel electrodes 151. In particular, the common electrodes 152 are formed on a surface of the second substrate facing the first substrate, and are made from a transparent material such as ITO (Indium-Tin Oxide) or the like. A pixel electrode 151, a common electrode 152 facing the pixel electrode 151, and liquid crystal molecules of the liquid crystal layer sandwiched between the two electrodes 151, 152 cooperatively define a crystal capacitor C_{lc} 153.

The gate lines 13 are connected to the gate driving circuit 11. The data lines 14 are connected to the data driving circuit 12.

FIG. 4 is an abbreviated timing chart illustrating operation of the active matrix LCD 10. The scanning signals G1-Gn are generated by the driving circuit 11, and are applied to the gate lines 13. The gradation voltages Vd are generated by the data driving circuit 12, and are sequentially applied to the data lines 14. The common voltage Vcom is applied to all the common electrodes 152. Only one scanning signal pulse 19 is applied to each gate line 13 during each one scan. The scanning signal pulses 19 are output sequentially to the gate lines 13.

Referring to FIGS. 3 and 4, the gate driving circuit 11 sequentially provides the scanning signal pulses (G1 to Gn) to the gate lines 13, and activates the TFTs 15 respectively connected to the gate lines 13. When the gate lines 13 are thus scanned, the data driving circuit 12 outputs gradation voltages (Vd) corresponding with image data of an external circuit to the data lines 14. Then the gradation voltages are applied to the pixel electrodes 151 via the activated TFTs 15. The potentials of the common electrodes 152 are set at a uniform potential.

Sum up, when one scanning signal pulse 19 is provided to a gate line 13, the liquid crystal capacitors C_{lc} connected to the activated TFTs 15 are charged to the gradation voltages, respectively. A charging time of each capacitor C_{lc} is equal to the duration of each scanning signal pulse 19. The gradation voltages written to the pixel electrodes 151 are used to control the amount of light transmission of the corresponding pixel units and consequently provide an image display for the active matrix LCD 10.

In FIG. 4, the gradation voltage Vd is a signal whose strength varies in accordance with each piece of image data, whereas the common voltage Vcom is a signal that has a constant value which does not vary at all.

If motion picture display is conducted on the active matrix LCD 10, problems of poor image quality may occur for various reasons. For example, the residual image phenomenon may occur because a response speed of the liquid crystal molecules is too slow. In particular, when a gradation variation occurs, the liquid crystal molecules are unable to track the gradation variation within a single frame period, and instead produce a cumulative response during several frame periods. Consequently, considerable research is being conducted with a view to developing various high-speed response liquid crystal materials that can overcome this problem.

Further, the aforementioned problems such as the residual image phenomenon are not caused solely by the response speed of the liquid crystal molecules. For example, when the displayed image is changed in each frame period (the period that the gate driving circuit 11 sequentially completes scanning from G1 to Gn once) to display the motion picture, the displayed image of one frame period may remain in a viewer's visual perception as an afterimage, and this afterimage overlaps with the viewer's perception of the displayed image of the next frame period. This means that from the viewpoint of a user, the image quality of the displayed image is impaired.

FIG. 5 is a timing chart illustrating a different mode of operation of the active matrix LCD 10, which mode is configured for mitigating or even eliminating any residual image effect of displayed images. For brevity, this mode of operation is referred to herein as a residual image reducing mode. The scanning signals G1-Gn are generated by the gate driving circuit 11, and are applied to the gate lines 13. The gradation voltages Vd are generated by the data driving circuit 12, and are sequentially applied to the data lines 14.

The operation of the active matrix LCD 10 in the residual image reducing mode includes the following steps:

a. A frame is divided into a first sub-frame “A” and a second sub-frame “B”.

b. In the first sub-frame “A”, the gate driving circuit 11 sequentially provides a plurality of first scanning signal pulses 391 to the gate lines 13, and activates the TFTs 15 respectively connected to the gate lines 13.

c. When the gate lines 13 are thus scanned, the data driving circuit 12 outputs the gradation voltages Vd corresponding to the image data to the data lines 14. Then the gradation voltages are applied to the pixel electrodes 151 via the activated TFTs 15.

d. In the second sub-frame “B”, the gate driving circuit 11 sequentially provides a plurality of second scanning signal pulses 392 to the gate lines 13, and activates the TFTs 15 respectively connected to the gate lines 13.

When the gate lines 13 are thus scanned, the data driving circuit 12 outputs a plurality of black-inserting voltages corresponding to black image data to the data lines 14. Then the black-inserting voltages are applied to the pixel electrodes 151 via the activated TFTs 15.

e. In a next frame, the steps “a” through “e” are repeated.

In the operation of the active matrix LCD 10 in the residual image reducing mode, the data driving circuit 12 provides the gradation voltages Vd corresponding to the image data to the data lines 14. After about a half of the frame has elapsed, the data driving circuit 12 provides black-inserting voltages corresponding to the black image data to the data lines 14. Accordingly, a viewer perceives the black image during the second sub-frame “B”, and an afterimage of the image displayed in the first sub-frame “A” is lost from the viewer's perception during the second sub-frame “B”. This means that there is no overlap of an afterimage with a perceived image of the next frame. Thus from the viewpoint of a user, the image quality of the displayed image is clear.

However, when the active matrix LCD 10 works in the residual image reducing mode, the gate line 13 needs to be double scanned in a frame. Thus a width of each scanning signal pulse 391 for scanning the gate line 13 needs to be halved. Therefore, a charging time of each crystal capacitor C_{lc} 153 which works in the residual image reducing mode is equal to a half of the charging time of each crystal capacitor C_{lc} which works in the normal mode. Thus the crystal capacitor C_{lc} 153 of the LCD 10 can't be charged to a predetermined gradation voltage in the residual image reducing mode sometimes. Therefore the display quality of the active matrix LCD 10 is decreased.

It is desired to provide an active matrix LCD that can overcome the above-described deficiency.

### SUMMARY

In one preferred embodiment, an active matrix LCD includes a plurality of first gate lines that are parallel to each other and that each extend along a first direction, a plurality of second gate lines that alternate with the first gate lines and that are extend along the first direction, a plurality of first data lines that are parallel to each other and that each extend along a second direction orthogonal to the first direction, a plurality of second data lines that alternate with the first data lines and that are extend along the second direction, a plurality of first thin film transistors (TFTs) each provided in the vicinity of a respective point of intersection of the first gate lines and the first data lines, a plurality of second TFTs each provided in the vicinity of a respective point of intersection of the second gate lines and the second data lines, a gate driving circuit for providing a plurality of first scanning signals to the first gate lines and providing a plurality of second scanning signals to the second gate lines, a data driving circuit for providing gradation voltage to the first data lines when the first gate lines are scanned and providing black-inserting voltage to the second data lines when the second gate lines are scanned.

Other advantages and novel features will become more apparent from the following detailed description when taken in conjunction with the accompanying drawings, in which:

### BRIEF DESCRIPTION OF THE DRAWINGS

FIG. 1 is an abbreviated circuit diagram of an active matrix LCD according to an exemplary embodiment of the present invention;

FIG. 2 is an abbreviated timing chart illustrating operation of the active matrix LCD of FIG. 1;

FIG. 3 is an abbreviated diagram including circuitry of a conventional active matrix LCD;

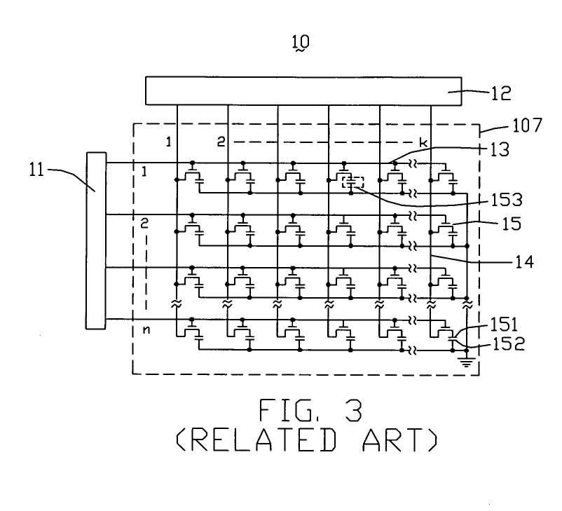

FIG. 4 is an abbreviated timing chart illustrating operation of the active matrix LCD of FIG. 3; and

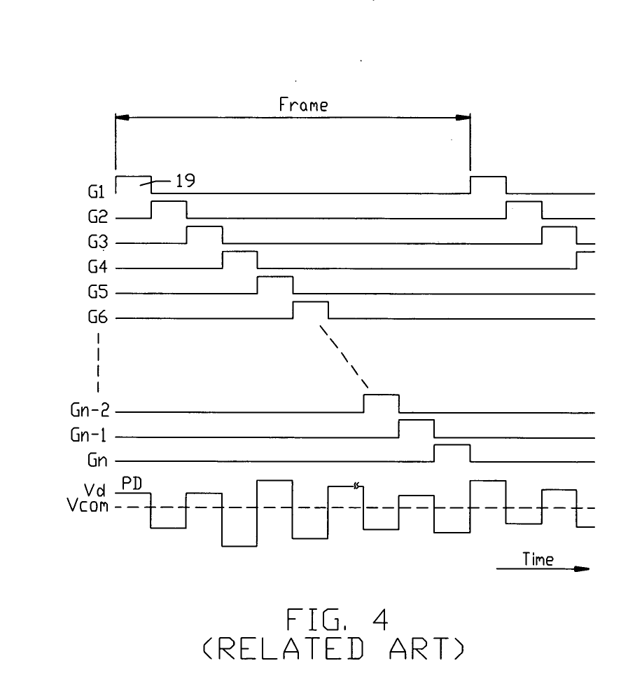

FIG. 5 is a timing chart illustrating a different mode of operation of the active matrix LCD of FIG. 3.

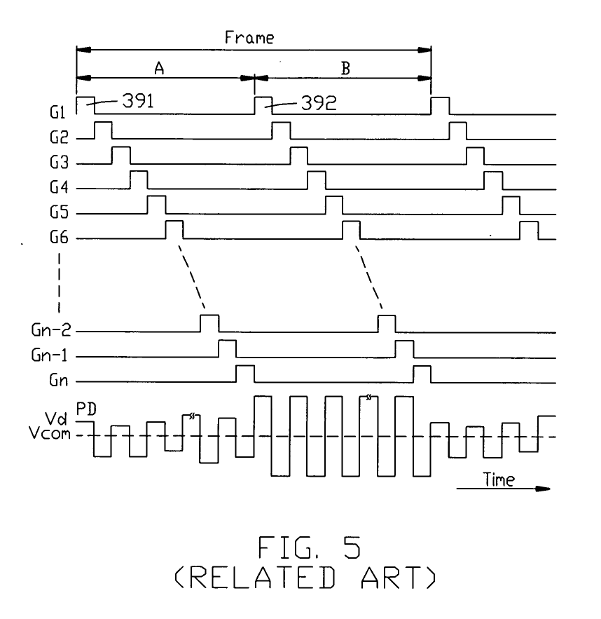

### DETAILED DESCRIPTION OF PREFERRED EMBODIMENTS

Reference will now be made to the drawings to describe the present invention in detail.

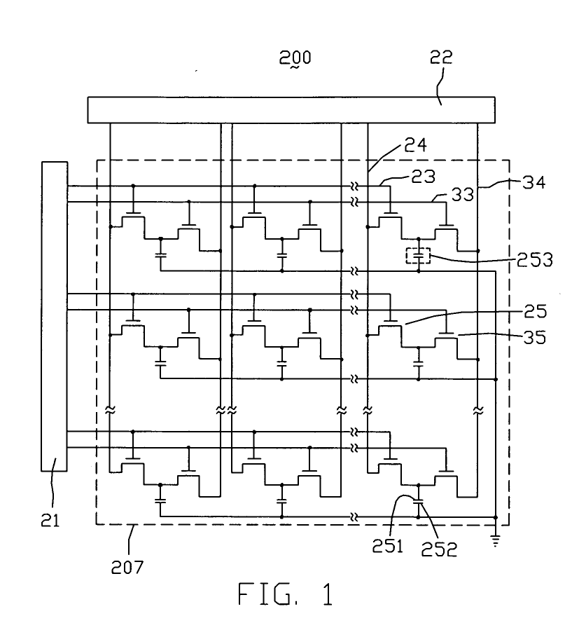

FIG. 1 is an abbreviated circuit diagram of an active matrix LCD according to an exemplary embodiment of the present invention. The active matrix LCD 200 includes a display panel 207, a data driving circuit 22, and a gate driving circuit 21. The display panel 207 includes a first substrate (not shown), a second substrate (not shown) arranged in a position facing the first substrate, and a liquid crystal layer (not shown) sandwiched between the first substrate and the second substrate.

The first substrate includes a plurality of first gate lines 23 that are parallel to each other and that each extend along a first direction, a plurality of second gate lines 33 that alternate with the first gate lines 23 and that are extend along the first direction, a plurality of first data lines 24 that are parallel to each other and that each extend along a second direction orthogonal to the first direction, and a plurality of second data lines 34 that alternate with the first data lines 24 and that are extend along the second direction. The smallest rectangle area made by the first gate lines 23 and the first data lines 24 defines a pixel unit (not labeled). A pixel unit includes a pixel electrode 251 formed on a surface thereof facing the second substrate. A pixel unit also includes a first thin film transistors (TFT) 25 and a second TFT 35 for driving the pixel electrode 251.

Each first TFT 25 is provided in the vicinity of a respective point of intersection of the first gate lines 23 and the first data lines 24. Each first TFT 25 includes a gate electrode, a source electrode, and a drain electrode. The gate electrode of the first TFT 25 is connected to the corresponding first gate line 23. The source electrode of the first TFT 25 is connected to the corresponding first data line 24. The drain electrode of the first TFT 25 is connected to a corresponding pixel electrode 251.

Each second TFT 35 is provided in the vicinity of a respective point of intersection of the second gate lines 33 and the second data lines 34. Each second TFT 35 includes a gate electrode, a source electrode, and a drain electrode. The gate electrode of the second TFT 35 is connected to the corresponding second gate line 33. The source electrode of the second TFT 35 is connected to the corresponding second data line 24. The drain electrode of the second TFT 35 is connected to a corresponding pixel electrode 251.

The second substrate includes a plurality of common electrodes 252 opposite to the pixel electrodes 251. In particular, the common electrodes 252 are formed on a surface of the second substrate facing the first substrate, and are made from a transparent material such as ITO (Indium-Tin Oxide) or the like. A pixel electrode 251, a common electrode 252 facing the pixel electrode 251, and liquid crystal molecules of the liquid crystal layer sandwiched between the two electrodes 251, 252 cooperatively define a crystal capacitor C_{lc} 253.

The gate lines 23 are connected to the gate driving circuit 21. The data lines 24 are connected to the data driving circuit 22.

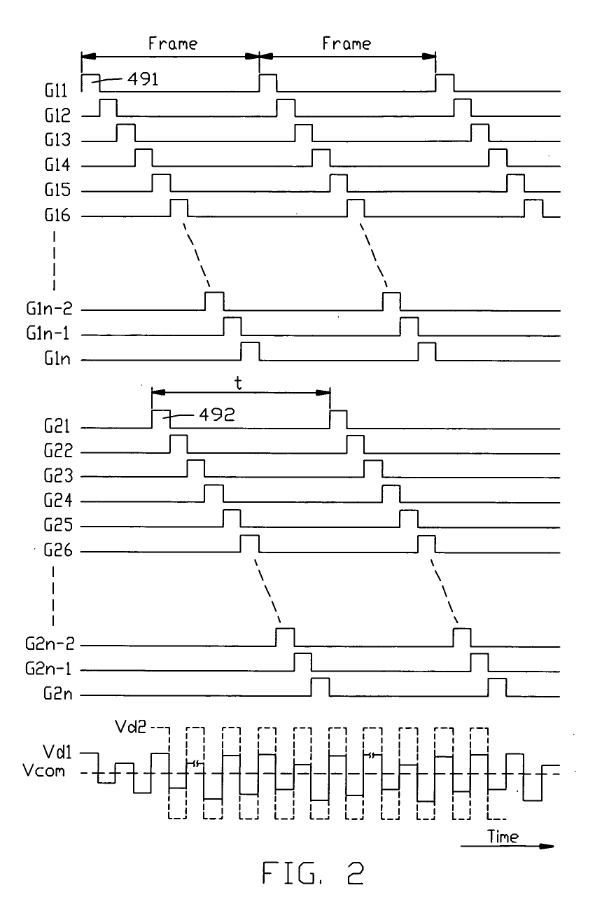

FIG. 2 is an abbreviated timing chart illustrating operation of the active matrix LCD 200. The first scanning signals G11-G1n and the second scanning signals G21-G2n are generated by the gate driving circuit 21, and are applied to the first gate lines 23 and the second gate lines 33, respectively. The gradation voltages Vd1 and the black-inserting voltages Vd2 are generated by the data driving circuit 22, and are applied to the first data lines 24 and the second data lines 34, respectively. The common voltage Vcom is applied to all the common electrodes 252. Only one of the first scanning signals 491 is applied to each first gate line 23 during each one scan. The first scanning signals 491 are sequentially output to the first gate lines 23. Only one of the second scanning signals 492 is applied to each second gate line 33 during each one scan. The second scanning signals 492 are sequentially output to the second gate lines 33. An interval between the first scanning signal 491 applied to the first gate line 23 and the second scanning signal 492 applied to the second gate line 33 adjacent to the first gate line 23 is less than a frame. For example the interval is equal to a half of one frame.

The gate driving circuit 21 sequentially applies the first scanning signals 491 (G11 to G1n) to the first gate lines 23 in a frame. When the first scanning signals 491 are provided to the first gate lines 23 by the gate driving circuit 21, the first TFTs 25 connected to the first gate lines 23 are activated by the first scanning signals 491. Then the data driving circuit 22 provides gradation voltage Vd1 corresponding with image data of an external circuit to the first data lines 24, and the gradation voltage Vd1 are written to the pixel electrodes 251 via the activated first TFTs 25. The potentials of the common electrodes 252 are set at a uniform potential. The gradation voltages written to the pixel electrodes 251 are used to control the amount of light transmission of the corresponding pixel units and consequently provide an image display for the active matrix LCD 200.

After half of one frame, the gate driving circuit 21 sequentially applies the second scanning signals 492 (G21 to G2n) to the second gate lines 33 in the frame “t”. When the second scanning signals 492 are provided to the second gate lines 33 by the gate driving circuit 21, the second TFTs 35 connected to the second gate lines 33 are activated by the second scanning signals 492. Then the data driving circuit 22 provides black-inserting voltage Vd2 corresponding with image data of an external circuit to the second data lines 34, and black-inserting voltage Vd2 are written to the corresponding pixel electrodes 251 via the activated second TFTs 35. The black-inserting voltage Vd2 written to the pixel electrodes 251 are used to control the amount of light transmission of the corresponding pixel units and consequently provide a black image display for the active matrix LCD 200.

Because the active matrix LCD 200 includes the first and second gate lines 23, 33 and the first and second data lines 24, 34, the gradation voltages Vd1 are written to the pixel electrodes 251 via the first data line 24 when the first gate lines 23 are scanned by the gate driving circuit 21, and the black-inserting voltages Vd2 are written to the pixel electrodes 251 via the second data line 34 when the second gate lines 33 are scanned by the gate driving circuit 21. Thus a frame needs not to be divided to two sub-frames for applying the first scanning signals 491 and the second scanning signals 492 to the first data lines 24 and the second data lines 34 respectively. A width of each first scanning signal pulse 491 for scanning the first gate line 23 is the same as the scanning signal 19 of the LCD 10 that works in a normal mode. Therefore, a charging time of each crystal capacitor C_{lc} 253 is enough, and the gradation voltage Vd1 can be written to each pixel electrode 251 of the crystal capacitor C_{lc} 253 in time. Thus the display quality of the active matrix LCD 200 is improved.

In an alternative embodiment, the black-inserting voltage can be an alternating current voltage or a direct current voltage. In another alternative embodiment, the interval between the first scanning signal 491 applied to the first gate line 23 and the second scanning signal 492 applied to the second gate line 33 adjacent to the first gate line 23 can be two fifths of one frame.

It is to be understood, however, that even though numerous characteristics and advantages of the preferred embodiments have been set out in the foregoing description, together with details of the structures and functions of the embodiments, the disclosure is illustrative only, and changes may be made in detail, especially in matters of shape, and arrangement of parts within the principles of the invention to the full extent indicated by the broad general meaning of the terms in which the appended claims are expressed.

What is claimed is:

1. An active matrix liquid crystal display (LCD), comprising:
a plurality of first gate lines that are parallel to each other and that each extend along a first direction;
a plurality of second gate lines that alternate with the first gate lines and that are extend along the first direction;
a plurality of first data lines that are parallel to each other and that each extend along a second direction orthogonal to the first direction;
a plurality of second data lines that alternate with the first data lines and that are extend along the second direction;
a plurality of first thin film transistors (TFTs) each provided in the vicinity of a respective point of intersection of the first gate lines and the first data lines;
a plurality of second TFTs each provided in the vicinity of a respective point of intersection of the second gate lines and the second data lines;
a gate driving circuit for providing a plurality of first scanning signals to the first gate lines and providing a plurality of second scanning signals to the second gate lines; and
a data driving circuit for providing gradation voltages to the first data lines when the first gate lines are scanned and providing black-inserting voltages to the second data lines when the second gate lines are scanned.

2. The active matrix LCD as claimed in claim 1, wherein an interval between the first scanning signal applied to the first gate line and the second scanning signal applied to the second gate line adjacent to the first gate line is less than a frame.

3. The active matrix LCD as claimed in claim 2, wherein the interval between the first scanning signal applied to the first gate line and the second scanning signal applied to the second gate line adjacent to the first gate line is equal to a half of one frame.

4. The active matrix LCD as claimed in claim 2, wherein the interval between the first scanning signal applied to the first gate line and the second scanning signal applied to the second gate line adjacent to the first gate line is equal to two fifths of one frame.

5. The active matrix LCD as claimed in claim 2, wherein the black-inserting voltage is an alternating current voltage.

6. The active matrix LCD as claimed in claim 2, wherein the black-inserting voltage is a direct current voltage.

7. A driving method of an active matrix LCD, wherein the active matrix LCD comprises a plurality of first gate lines that are parallel to each other and that each extend along a first direction, a plurality of second gate lines that alternate with the first gate lines and that are extend along the first direction, a plurality of first data lines that are parallel to each other and that each extend along a second direction orthogonal to the first direction, a plurality of second data lines that alternate with the first data lines and that are extend along the second direction, a plurality of first thin film transistors (TFTs) each provided in the vicinity of a respective point of intersection of the first gate lines and the first data lines, a plurality of second TFTs each provided in the vicinity of a respective point of intersection of the second gate lines and the second data lines, a gate driving circuit connected to the first and second gate lines, and a data driving circuit connected to the first and second data lines, the method comprising:
sequentially generating a plurality of first scanning signals to scan the first gate lines by the gate driving circuit;
providing a plurality of gradation voltages to the first data lines when the first gate lines are scanned by the data driving circuit;
sequentially generating a plurality of second scanning signals to scan the second gate lines by the gate driving circuit; and
providing black-inserting voltages to the second data lines when the second gate lines are scanned by the data driving circuit;

8. The driving method as claimed in claim 7, wherein further comprising an interval between the first scanning signal applied to the first gate line and the second scanning signal applied to the second gate line adjacent to the first gate line is less than a frame.

9. The driving method as claimed in claim 8, wherein the interval between the first scanning signal applied to the first gate line and the second scanning signal applied to the second gate line adjacent to the first gate line is equal to a half of one frame.

10. The driving method as claimed in claim 8, wherein the interval between the first scanning signal applied to the first gate line and the second scanning signal applied to the second gate line adjacent to the first gate line is equal to two fifths of one frame.

11. The driving method as claimed in claim 7, wherein the black-inserting voltage is an alternating current voltage.

12. The driving method as claimed in claim 7, wherein the black-inserting voltage is a direct current voltage.

13. An active matrix liquid crystal display (LCD), comprising:
a plurality of first gate lines that are parallel to each other and that each extend along a first direction;
a plurality of second gate lines that alternate with the first gate lines and that are extend along the first direction;
a plurality of first data lines that are parallel to each other and that each extend along a second direction orthogonal to the first direction;
a plurality of second data lines that alternate with the first data lines and that are extend along the second direction;
a plurality of ground lines that extend along the first direction wherein every adjacent two ground lines sandwich one corresponding first gate line and one corresponding second gate line;
a plurality of first thin film transistors (TFTs) each provided in the vicinity of a respective point of intersection of the first gate lines and the first data lines;
a plurality of second TFTs each provided in the vicinity of a respective point of intersection of the second gate lines and the second data lines; wherein
each of said first TFTs cooperates an adjacent one of said second TFTs as a pair to commonly share an area confined by two adjacent data lines and two ground lines.

14. The active matrix liquid crystal display as claimed in claim 13, wherein in each pair, a drain electrode of the first TFT shares a same capacitor with that of the second TFT.
